(19) United States
(12) Patent Application Publication
(10) Pub. No.: US 2015/0177100 A1
(43) Pub. Date: Jun. 25, 2015

(54) METHOD AND APPARATUS FOR DETECTING AND MONITORING STATES

(71) Applicant: IMO Holding GmbH, Gremsdorf (DE)

(72) Inventor: Volker Dietz, Hochstadt (DE)

(21) Appl. No.: 14/419,871

(22) PCT Filed: Jul. 9, 2013
(86) PCT No.: PCT/DE2013/000372

§ 371 Date: Feb. 5, 2015

(30) Foreign Application Priority Data
Aug. 9, 2012 (DE) 10 2012 015 654.5

(51) Int. Cl. G01M 13/04; G01M 15/14; G01L 1/26

(52) U.S. Cl. CPC G01M 13/04; G01L 1/26; G01M 15/14

(57) ABSTRACT

The invention relates to a state-detecting and state-monitoring system (100) for the at least temporary, possibly periodic, preferably even permanent, value-, signal-or data-based acquisition and monitoring of state parameters of at least one assembly (K) or component, or even sub-elements of this assembly or component, in particular at least of a bearing or a rotary connection, for example in or on a wind turbine, and also relates to an associated method, characterized by: at least one, preferably more than two, contact sensor(s) (3) attached to or incorporated in the subassembly (K) or component, preferably which can be attached or incorporated directly or indirectly, can for example be attached or incorporated at an incorporating location (A), in particular at or on a planar or rounded surface (1) or contour of this assembly (K) by means of screwing/inserting/welding/brazing/adhesive bonding or clamping in the vicinity of a bearing ring in a wind turbine, preferably of a nose ring or support ring or retaining ring of a slewing bearing, alternatively which can be attached or can be incorporated directly at or on at least one inner or outer surface of a blade, main or tower bearing of a wind turbine.

The invention relates to a condition detection and monitoring system for the at least intermittent, possibly periodic, preferably even ongoing, value-, signal-or data-based detection and monitoring of condition parameters of at least one assembly or component, or even sub-elements of this assembly or component, in particular at least of a bearing or a slewing ring, for example in or on a wind turbine, and also relates to an associated method. Characterizing the invention is at least one contact sensor that is attached to or incorporated into the assembly or component and preferably can be attached or incorporated directly or indirectly at an incorporation site, particularly at or on a planar or rounded surface or contour of this assembly, for example can be attached or incorporated by screwing/insertion/welding/brazing/adhesive bonding or clamping in the vicinity of a bearing ring in a wind turbine, preferably a nose ring or support ring or retaining ring of a large rolling bearing, alternatively that can be attached or incorporated directly at or on at least one inner or outer surface of a blade bearing, main bearing or tower bearing of a wind turbine.

### PROBLEM/INITIAL SITUATION/PRIOR ART

In the current state of the art, present-day slewing rings and rolling bearings, for example large rolling bearings in wind energy systems, always have to be greased with a lubricant (oil or grease), for example to reduce friction, prevent the bearing from seizing, and thus achieve the longest possible service life for the bearing and the raceway system components.

Many bearing and system manufacturers have been developing interesting technical solutions for the detection and monitoring of problems due to inadequate lubrication and wear that might cause the premature failure of bearings or slewing rings and their raceway system components. For example, EP 2153077 B1 describes a device for the detection and monitoring of damage to rolling bearings that employs the transfer of electrical energy by inductive coupling.

EP 2306006, for example, presents a condition monitoring system for wind turbines that uses a plurality of acceleration sensors to monitor the operation of the wind turbine. The monitoring torque seems to concentrate on the system as a whole rather than on subareas thereof. EP 0529354, in contrast, relates to a device for monitoring the rolling bearing itself in which sensors are disposed between the rolling elements, in the space where they are located, and generate data for electromagnetic transmission. Finally, EP 0637734 describes a monitoring system for measuring the loads acting on a rolling bearing, in which this measurement is to take place inductively, through the use of coils, and which employs sensors disposed inside the raceway system.

Only a few of these detection and monitoring systems are also technically mature. Most of these systems are not fully reducible to practice. Consequently, few of them have actually gained widespread acceptance so far, for example by being used in rolling bearings of wind energy systems.

However, many manufacturers and operators of wind energy systems have opted, for example, to circumvent the problems caused by inadequate lubrication and the resulting wear by providing a permanent supply of fresh lubricant. WO 2010/125000 describes a bearing for wind energy systems that includes fluid canisters mounted on the periphery of the outer bearing ring to supply the bearing with fresh lubricant. Finally, EP 1273814, for example—which is also of earlier priority, dating from 2002—describes such a device for improving the lubrication of rolling bearings, particularly for bearings used in wind turbines. In that idea, a plurality of lubricant bellows filled with lubricant are installed segmentally on the bearing rings in order to inject this lubricant into the raceway system of the bearing on an as-needed basis. The injection of the lubricant is controlled, for example, via a central lubrication system (CLS). A controlled lubricant feed is therefore present here. The old, used lubricant is removed from the bearing or slewing ring by multiple paths, through outlet seals. This approach does not generally involve any “sensing,” i.e., sensory detection of the actual lubricating effect in the bearing, particularly sensory detection by electrical or electronic means, with a downstream feedback control circuit. It is, in fact, no small matter to achieve satisfactory monitoring of lubrication and wear conditions in bearings and raceway system components, since actual monitoring and wear sensors often have to be introduced into the raceway system itself. A large percentage of such monitoring and wear sensors nowadays are in the form of electronic or electromechanical components.

However, electronics that have to exist in adverse conditions in a raceway system must satisfy very high requirements in terms of their ability to withstand environmental influences such as high temperature differences, resistance to high pressures, high requirements in terms of withstanding mechanical loads such as the pulling and pushing forces and torsion that are present, and finally, also, high requirements in terms of resistance to fluids (oil, lubricants). In practice, inventions in the field of bearing and slewing ring technology that have electronic assemblies or electronic components present in the raceway system show increased failure rates of these electronic components or sensors.

These requirements are roughly comparable to the environmental requirements found, for example, in the requirement specifications for automotive electronics.

Adding to the difficulty is the fact that any chips or nicks that may develop with wear and tear on the bearing or slewing ring over time can move around “loose” in the raceway system, thereby disrupting, fouling or damaging the electronics in the raceway system. Such disruption or damage can lead to the destruction of the electronics or sensors present in the raceway system.

To summarize, it is currently very difficult to devise a raceway-internal electronic monitoring unit that can match the service life of a bearing or slewing ring and is able to reliably monitor the lubrication and wear conditions of the bearing and the raceway system components. Other inventions, which merely offer lubricant management in the sense of a controlled lubricant supply, often do not possess the more elaborate feedback-control and sensor mechanisms that would be needed to ensure reliable lubrication and wear condition monitoring.

### OBJECT/SOLUTION/DESCRIPTION OF THE INVENTION

The solving idea behind the present invention is the potential for development that arises from the above-cited current problems of the prior art. The present invention is directed to solving the problem initiating the invention by providing a condition detection and monitoring system that enables intermittent, for example periodic, preferably even ongoing, detection and monitoring of condition parameters of the monitored assemblies and components, so that statements can be made regarding the respective current condition of the monitored assembly or assemblies and component or components, which can be a bearing or a large rolling bearing or a slewing ring or even portions thereof.

An additional purpose of achieving the object by means of the condition detection and monitoring system is to be able to make proactive statements concerning, for example, one of the three operating parameters “lubricating effect,” “lubricant condition,” “wear condition.” These proactive statements are intended to provide information in the form of weighted results that will indicate whether the assembly(-ies)/component(s) being monitored for “lubricating effect” or “lubricant condition” or “wear condition” must be expected, or can with a given probability be expected, to exhibit damage, defects or total failure within a foreseeable period of time.

It is further an object of the invention that the sensors essential to the condition detection and monitoring system, particularly the contact sensors described in detail below, but preferably also the secondary sensors described below, not be disposed inside the raceway system, since they are more vulnerable to failure or trouble there, but instead that it be possible to attach them or incorporate them from the outside to or into the assemblies to be monitored, for example on the respective outer surfaces of the monitored assemblies and components. The terms “auxiliary sensor” or “secondary sensor system” will be used synonymously with the term “secondary sensors.”

In a still further developed embodiment of the invention, the condition detection and monitoring system according to the invention achieves the object of being able to recognize up to forty different operating patterns that are characteristic of impending damage to elements or components, particularly to bearings or slewing rings.

If such an operating pattern is reliably detected with the probability that exists in the particular case, in a particular embodiment of the invention this operating pattern can be recognized consistently as anomalous operating behavior. Consequently, there is a given probability that an “error” is present in the components being monitored. The condition detection and monitoring system is able to store at least one “error code” or “error diagnosis code” for this error. This “error code” or “error diagnosis code” can be passed on.

The invention thus provides a method and a device for the detection and monitoring of the condition that is consistent with early condition detection (condition (based) monitoring, service and diagnosis) in bearings/rolling bearings and large rolling bearings and in slewing rings. The advantages of the invention enhance the serviceability and diagnosability of the monitored assembly or component, for example a bearing, a large rolling bearing or a slewing ring.

The invention likewise offers improved characteristics with regard to software-based modeling and analysis of the monitored assemblies or components, which, under the right circumstances, can be performed after the condition detection and monitoring. Such software-based modeling and analysis can take place, for example, in a central or control computer, which is preferably spatially separated from the particular assemblies or components, or the assembly or component, being monitored.

The invention thus takes a novel approach compared to the ideas pursued heretofore in the above-described current prior art. The prior art displays a wide variety of solutions for incorporating sensors and electronics into the raceway system in order to detect measurement values inside the raceway system. This is disadvantageous for the reasons stated above: high requirements in terms of the ability to withstand environmental influences such as high temperature differences, resistance to high pressures, high requirements in terms of withstanding mechanical loads such as the tensile and compressive forces and torsion that are present, and finally, also, high requirements in terms of resistance to fluids.

Sensors or electronics that can be attached or incorporated from the outside, as will be explained below in the context of the present invention, usually have to meet lower stability requirements than sensors or electronics that are to be incorporated into the raceway system, and are therefore more advantageous.

The inventive ideas create a system solution for detecting at least one of the following three conditions: “lubricating effect” or “lubricant condition” or “wear condition.” The solution according to the invention is particularly successful when embodied as a condition detection and monitoring system that serves to detect and evaluate condition changes potentially having a negative impact on the service life of an assembly or component by the periodic, preferably ongoing, particularly temporally continuous, evaluation of signals and measurement values.

Hence, the particular assembly or component to be monitored, for example a bearing or a slewing ring, is monitored by means of the inventive solution subject to the condition of at least intermittent or periodic, but preferably ongoing, reception of actual values or actual data, which are compared continuously and insofar as possible uninterruptedly with stored nominal values or nominal data. With the aid of a knowledge database that can be accommodated or installed externally, for example in the above-described central computer, decisions are made regarding the current condition, for example, of the monitored bearing or the monitored slewing ring using statistical probabilities.

The terms “knowledge database,” “knowledge base” and “knowledge data bank” are to be construed as interchangeable in the context of this description. This knowledge database can either be input into or present in an (advanced) IT and electronic system, or, alternatively, can be input into or present in the above-described central computer. Stored in this knowledge database or knowledge base are, in addition to so-called threshold data or threshold values, predefined characteristic diagrams and operating patterns, so-called knowledge data or knowledge values.

The term “(advanced) IT and electronic system” will be explained later on in the description.

Proceeding from the physical operating principle and the condition created by various kinds of component damage, for example various kinds of bearing damage, various changes in the traveling or rolling noises in this component or in adjacent components, for example in a bearing, conclusions can be drawn regarding the respective current conditions inside the component/bearing by careful reception or detection of the oscillations or vibrations or noises of this component, for example of the bearing.

It is particularly advantageous and within the teaching of the invention that this reception of the oscillations or vibrations or noises be performed by contact sensor systems mounted on the outer surfaces of the component, so that conclusions can be drawn as to the conditions then prevailing inside the component.

The terms “reception” or “detection” are to be considered here as interchangeable with the term “measurement.” In the following description, the terms “oscillation” or “vibration” will also be referred to for purposes of simplification as “noise.” That being the case, the terms “oscillation,” “vibration” and “noise” are to be construed as interchangeable.

With reference to a bearing or a slewing ring, this means that the traveling/rolling noises of the bearing/slewing ring are received or measured by means of contact sensors attached to or incorporated in the outer surfaces of the bearing/slewing ring. These bearing noises, together with any auxiliary or secondary signals, can then, for example, be amplified and filtered as well as evaluated. The evaluation of these received bearing noises and any auxiliary signals generates, according to the invention, knowledge or conclusions that are subject to probability, but are still in most cases technically useful, regarding the current conditions inside the assembly or component, for example the bearing or the slewing ring.

The term “sensor systems having secondary functions” will be used synonymously below in place of the term “secondary sensor systems.” The term “auxiliary signal” in the conceptual sense should be understood in the context of the description to mean signals that can be received or detected by means of secondary sensors. Such an “auxiliary signal” or “secondary signal” can, for example, be, but is not limited to, a detected signal, a detected value or a detected datum relating to rotation speed condition, position condition, acceleration condition, temperature condition, pressure condition or lubricant condition. In a further embodiment of the invention, a velocity condition can also be a “secondary signal.”

Thus, both contact sensors and auxiliary sensors serve to detect the conditions in the assembly or component being monitored.

It is also conceivable and in accordance with the invention that the secondary sensors be able to receive or detect both current operating conditions, i.e., current instantaneous values, and conditions averaged over a set time period, i.e., for example, average rotation speed, average acceleration, average temperature, average pressure or average lubricant condition.

Bearings that may be contemplated as the bearing or slewing ring according to the invention include all of the common forms and designs of slewing rings or rolling bearings or large rolling bearings, as well as torque bearings, that are to be found in the history and current state of the art, for example but not limited to: single-or multi-row four-point bearings, cylindrical roller bearings, combination bearings, crossed roller bearings, tapered roller bearings, wire bearings, single-or multi-row special slewing rings, ball slewing rings, roller slewing rings, crossed roller slewing rings, roller/ball combination slewing rings, and all pitch bearings and tower or azimuth bearings, main or rotor bearings, etc., commonly present in or usable in wind energy systems.

This particular bearing or slewing ring serves to absorb either axial and/or radial forces and moments. A further embodiment of the invention permits the additional use of grooved ball bearings, self-aligning ball bearings, single or double angular-contact ball bearings, axial groove ball bearings, needle bearings and self-aligning roller bearings, barrel roller bearings, and even toroidal roller bearings.

Naturally, in the sense of the invention the aforesaid contact sensors, optionally in combination with additional, secondary sensor systems, can also be attached to or incorporated in outer surfaces of the slewing rings of slew drives. By the same token, it is also possible and consistent with the invention to attach or incorporate contact sensors on the housing or the contour, or on portions of the housing, of the slew drives.

As to the concept of “slew drive”: a slew drive, also referred to in the literature as a “slewing drive” (or “swivel drive” or “pivoting drive”), differs from slewing rings (or “slew rings”) or from rotational bearings or torque bearings by the fact that the slewing ring or the bearing present in the slew drive has toothed elements, and these toothed elements are in direct contact with a worm shaft. This worm shaft can be set in rotary motion by a hydraulic or electric motor or by a pump, the rotational movement thus being transmitted, via the meshing flanks of the teeth of the worm shaft, to the toothed elements of the slewing ring or the bearing. The contact sensors are also, of course, suitable for use in worm-driven slew drives, as well as for use with pinion-driven slew drives. Likewise, the secondary sensors are suitable both for use in worm-driven slew drives and for use with pinion-driven slew drives.

It is particularly within the scope of the invention if the contact sensors are attached to or incorporated into, for example fixedly adhesive-bonded to, the outer surfaces of the bearing or the slewing ring. It is also possible and conceivable for the contact sensors to be varnished onto or into one or more of the outer surfaces, or, alternatively, for the contact sensors to be laminated into the layer sequence of the particular outer surface, as long as the structures and dimensions of the contact sensor permit this method of application or incorporation. The same applies to the secondary sensors.

In the remainder of the description, the term “contact sensor” will be used synonymously with the term “contact sensor assembly.”

The same function as that of a contact sensor or a contact sensor assembly is performed by the “sensor mat” or “sensor network” described below. Such a “sensor mat” or “sensor network” also constitutes a “contact sensor system” in the sense of the invention. That contact sensor system, as well as any discrete contact sensor or any contact sensor assembly, can function as a relatively simple receiver or detector capable of detecting signals or noises by physical means only, as well as a relatively intelligent (or “smart”) sensor, preferably with an associated logic or electronic assembly, optionally even with a coupled microcontroller, such an intelligent sensor being able to process and forward the detected values, signals or data, i.e., for example the received noise, by means of an integrated microprocessor and control unit and an arithmetic unit, and possibly memory and interface modules integrated into said microprocessor. All of the aforesaid levels of realization of such an intelligent sensor are within the scope of the invention.

At a minimum, however, for example at the simplest and usually most inexpensive level of realization, the contact sensor or contact sensor system according to the invention includes one or more means for physically receiving or detecting the signals or noises. These respective means for physically receiving or detecting noises by means of the contact sensor system can basically be divided into three categories. First: piezoelectric receivers/detectors. Second: inductive receivers/detectors. Third: capacitive receivers/detectors.

The same applies to the secondary sensor system: at a minimum, for example at the simplest and most inexpensive level of realization, a secondary sensor comprises one or more means for physically receiving or detecting secondary signals. A secondary sensor can function as a receiver or detector that is capable of detecting secondary signals merely physically, as well as a relatively intelligent sensor (analogously to the above description) with a coupled logic module or electronic module, for example through the use of an integrated microprocessor and control unit and an arithmetic unit, and possibly integrated memory and interface modules. All of the aforesaid levels of realization of such an intelligent secondary sensor are within the scope of the invention.

According to the invention, contact sensors with piezoelectric receivers are advantageously directly, i.e., physically, attached to or incorporated into the surface or contour of the assembly or component to be monitored. A sensor-internal membrane, which can be in punctiform or areal contact with the surface or contour, is preferably connected to the inside of the contact sensor. If noises, vibrations, oscillations occur in the assembly or component being monitored, then these noises are received by the contact sensor as follows: This oscillation corresponds to a variety of mechanical changes in the position and/or extent of the membrane. These mechanical changes are transferred, for example, to piezoelements physically attached to the membrane. According to the piezoelectric effect, mechanical changes in the piezoelectric material generate electrical potential differences, preferably at the ends of the piezoceramic element. Electrical potential differences cause electrical voltage. This electrical voltage is routed to an interface.

In a further embodiment of the piezoelectric receiver, the sensor-internal membrane can be omitted.

Turning now to contact sensors with inductive receivers, these are also preferably directly/physically attached to or incorporated into the surface of the assembly or component to be monitored. See above. A sensor-internal membrane can be set in oscillation by the received signals or noises. This oscillation corresponds to multiple mechanical changes in the position and/or extent of the membrane. These mechanical changes are transferred, for example, to permanent magnets physically attached to the membrane; the respective permanent magnet is immersed in a coil or is able to move along said coil, i.e., relative to the coil. Under the principle of electrical induction, mechanical changes of position generate electrical potential differences in a magnetic field. Electrical potential differences cause electrical voltage. Electrical potential differences cause electrical voltage [repetition sic]. This electrical voltage is routed to an interface. In a further embodiment of this inductive receiver, the sensor-internal membrane can be omitted.

In a further embodiment of this inductive receiver, a coil is able to move inside a permanent magnetic core, i.e., relative to the permanent magnetic material, and thereby induce voltage. Alternatively, it is possible for both magnetic poles to be formed of electromagnets. Induction is then brought about by the movement of these two magnetic poles in relation to each other. In that case, the operating principle of such an inductive receiver is based on the principle of a moved conductor combined with a magnetic field. Electrical potential differences cause electrical voltage. This electrical voltage is routed to an interface.

Contact sensors with capacitive receivers are also, for example, directly/physically attached to or incorporated into the surface of the assembly or component to be monitored. A sensor-internal membrane can be set in oscillation by the received signals or noise. This oscillation corresponds to multiple mechanical changes in the position and/or extent of the membrane. These mechanical changes are transferred, for example, to one or more electrode(s) physically attached to the membrane. According to the laws of electrical science, mechanical changes in the electrical field generate differences in capacitance, which cause electrical potential differences. Electrical potential differences cause electrical voltage. This electrical voltage is routed to an interface.

In a further embodiment of the capacitive receiver, here again the sensor-internal membrane can be omitted.

The physical basis—as it is currently scientifically understood—of the operating principle of “vibration” or “oscillation” analysis will be referred to and described below simply as “noise” analysis:

An elastic solid, unlike a still fluid, is able to absorb shear stress as well as normal stress. Two kinds of structure-borne sound waves—longitudinal waves and transverse waves—can therefore propagate in a solid that is unbounded on all sides. These waves propagate independently from one another. In both cases, the sound velocity is largely independent of frequency. The sound velocity is influenced by the density, the shear modulus (in the case of transverse waves) and the modulus of elasticity (in the case of longitudinal waves).

The assemblies and components being monitored or to be monitored according to the present invention are solid bodies, preferably solid bodies with bounded surfaces and contours, for instance with planar contact surfaces or axial or radial rounded outer surfaces. As noise propagates in the assembly, longitudinal and transverse waves become coupled, thus giving rise to other kinds of mechanical structure-borne sound waves. The most significant type of wave is bending waves, in which bending deformations occur. The sound velocity of these waves is much lower than that of the longitudinal and transverse waves, and it is frequency-dependent (scatter). However, bending waves usually carry much more sound energy and are the main cause of the emission of airborne sound.

All of the other waves described above are referred to as “noise” in the sense of the invention.

The contact sensor according to the invention, or—very generally—the system of contact sensors present in a system, serves basically as a receiver/detector for this “noise.”

The condition detection and monitoring system is capable both of analyzing this “noise” received/detected by the contact sensor system and of supplying processed signals/data/values for other uses. Particularly, in this connection, the variables detected/received by the secondary sensors can be computer-processed to extract condition information regarding the operation of the monitored system. In relation to a wind energy system, these operating conditions can be:

The rotation speed of the rotor or the drive shaft, the position of the gondola in the case of azimuthal adjustment and/or the position of adjusted (or “pitched”) blades, the pressure in the pressure reservoir of the hydraulic system, the fill level of the hydraulic system or the lubrication system, the output of the wind turbine, the current and average wind velocity, the temperature of the lubricant—oil, for example—or the coolant, the current and average temperature of the bearing, the current and average outside temperature, etc.

With reference to a wind energy system, not only does the invention recommend installing secondary sensors on the bearing or slewing ring, but it has also proven advantageous to additionally mount secondary sensors in or on the generator and in or on the main gearbox, as well as in or on the gondola—in a further embodiment of the invention, for example, as wind velocity meters on the gondola. To obtain information on other operating conditions, it is also advisable to receive/detect temperatures in or on electrical power transmitters or to measure the winding temperatures in the main generator or on other generator modules.

The condition detection and monitoring system corresponding to the invention satisfies the following criteria in terms of characteristics: compatibility with common data processing and information technology systems, especially with advanced information technology and electronic systems, a high degree of automation, retrofittability with commercially available software systems and operating systems, the fact of being web-based, documentation capabilities and support of reporting functions.

The IT and electronic system according to the invention is connected or connectable to at least one, preferably to a plurality of, evaluation units, for example mechatronic or electronic evaluation units. In a further embodiment of the invention, these evaluation units are part of the IT and electronic system.

The present condition detection and monitoring system includes or contains at least one such, possibly advanced, IT and electronic system and at least one knowledge database, as well as at least one of the above-described contact sensors, but preferably a network composed of a plurality of the above-described contact sensors, as well as at least one of the above-described secondary sensors or an interconnected array of secondary sensors.

All sensors, both contact and secondary, can be connected by electrical wiring to the component or element to be detected or monitored, i.e., for example, by means of electrical wiring or bus lines leading to and from the bearing or slewing ring. Wireless communication technology is preferred, however.

The manner of operation of the contact sensors, which also communicate by wire or preferably wirelessly with partner units, is based on the above-described principle of operation of the reception/detection of noise. The received/detected signals/data/values are evaluated by subsequent “noise” analysis. All of the sensors just enumerated are usually, in a preferred embodiment, located in the immediate vicinity of the element or component to be monitored.

The electrical voltage present at the output of such a contact sensor, for example at the output of the inductive or capacitive or piezoelectric sensor, which voltage may, if appropriate, be monitored and observed by additional electrical measuring devices, is relayed to a partner unit, preferably the evaluation unit, optionally with prior amplification or filtering of the signal/datum/value. This processing step of amplification or filtering is optional and can be omitted if the information is of sufficient quality. According to the invention, this amplification or filtering of the signal/datum/value can take place in an evaluation unit and/or in the IT and electronic system.

The reception/detection of the above-cited “noise” by means of the contact sensors can, for example, include the use of anti-aliasing filters. For example, for noise with a frequency of 10 kHz, a signal sampling rate of 20 kHz is used. Control of the filtering is preferably handled by the advanced IT and electronic system. Signal filtering can also take place in the described evaluation unit.

The evaluation of the component noise, for example the bearing noise, picked up by the contact sensors, as well as that of any secondary signals acquired, serves to identify characteristic frequency components and sound amplitudes: for example, damage in a bearing or slewing ring can not only affect the amplitudes and harmonics of tooth engagement vibration, it can also cause other modulation waves. The received/detected noise spectrum is then changed in comparison to the noise spectrum of an undamaged bearing or slewing ring. This change can be rendered observable in the frequency range essentially by three refining analytical methods that serve to amplify and filter the data:
analysis of the amplitude spectra,
cepstrum analysis,
envelope curve analysis
and
analysis of frequency-selective characteristic values.

According to the teaching of the invention, these three refining analytical methods are ideally performed by or in the advanced IT and electronic system(s).

The functionality of the secondary sensors can be based on different or plural operating principles, for example on temperature measurement and/or pressure measurement and/or rotation speed measurement and/or acceleration measurement and/or velocity measurement and/or lubricant condition determination, possibly also on the basis of incremental sensor technology of the kind known from position identification.

For example, with the aid of the advanced IT and electronic system, at least some of the following ten vibration parameters can be read from the signals/data/values supplied by the contact sensors, also taking into account any signals/data/values from secondary sensors, or they can be converted or determined in one of the externally installed evaluation unit(s), if any:

Sound pressure, sound pressure level, sound particle velocity, sound particle displacement, sound acceleration, sound intensity, sound power, sound energy density, sound energy flux, etc. Of particular interest, however, is sound particle velocity, which satisfies the equation c=λ·f, in other words [sound particle velocity=[wavelength] times [frequency], and which is strongly dependent on the material and the medium.

Alternatively, it is possible to determine the above-listed vibration parameters, for example, in the above-described central computer. In a further embodiment of the invention, the at least one evaluation unit is also capable of making this determination. If the above-described intelligent sensors (or smart sensors) in the sense of the invention are used, in a technically very mature realization of the invention the above-listed vibration parameters can optionally also be calculated in the intelligent sensor or in the intelligent sensor network.

All the detected/received signals/data/values that are not directly physically related to the above-listed vibration parameters, i.e., secondary signals such as current or average temperatures and/or pressures and/or rotation speeds and/or accelerations and/or velocities and/or lubricant conditions, etc., are received/detected in the sense of the invention solely by means of the secondary sensors.

Both the value-, signal-or data-based connection between the contact sensor and the—optionally externally installed—evaluation unit and the value-, signal-or data-based connection between a secondary sensor and an evaluation unit are based on currently accepted protocols and messaging services.

In attaching or incorporating all the wire-connected sensors to or into the assembly or component, it is important that those sensors which are connected by wire to downstream evaluation or electronic units preferably be disposed on an element or component that is not constantly rotating or constantly in vigorous motion. This is necessary in practice merely to keep the wires from getting wound up or torn away.

In the preferred embodiment of the invention, the connection of all sensors to the evaluation unit is always effected wirelessly: thus, transmission takes place, for example, via radio link(s) instead of via discrete wires or bus lines. In this preferred case, each of these sensor systems, both the contact sensor system and the secondary sensor system, advantageously has its own electrical power supply. A particularly advantageous feature of the wireless embodiment of the invention is that the above-described problem of the wires getting wound up or torn away is not present.

The inventive solution constituted by the condition detection and monitoring system is further capable of performing comparisons of the detected (electrical) signals/values/data with the set limit values of the assembly or component to be monitored, for example of a bearing or a slewing ring in a wind energy system. Measurement fluctuations, for example fluctuations of rotation speed during the dynamic operation of the assembly or component, can be taken into account in this process.

An IT and electronic system according to the invention is in principle able to support the following three arithmetic operations, but ideally is able to perform them itself:
FFT (fast Fourier transformation) of the detected frequency spectrum,
envelope curve analysis of the detected frequency spectrum,
and
corresponding order analysis.

This order analysis is to be understood here as the plotting of the detected frequency spectra as order spectra.

If the inventive solution is used, for example, to detect and monitor bearings and slewing rings in wind energy systems, then the condition detection and monitoring system is, in principle, technically capable of monitoring the following elements or components:
main bearing,
tower bearing or azimuth bearing,
blade bearing,
but also any gear bearings or generator bearings that may be present.

By virtue of the inventive condition detection and monitoring system, therefore, the aforesaid components of the wind energy system are subjected to at least intermittent, or better, periodic, or, ideally, even ongoing monitoring by the condition detection and monitoring system. Attached to or incorporated into these bearings to be monitored is, for example, a plurality of contact sensors, for example at least one per bearing, possibly as many as between two and ten per bearing, for the reception/detection of noise signals/values/data, the so-called actual values or actual data.

In a specific embodiment, a total of four contact sensors per bearing are, for example, adhesive-bonded onto, welded onto or brazed into the axial outer surface and also the bottom outer surface that is axially offset parallel thereto; are laminated, screwed or inserted or clamped into the varnish layer sequence; or are simply attached by means of installation, mounting or retaining plates or retaining devices.

The term “outer surface” in the sense of the invention need not necessarily be construed as the surface located on the radially outermost side of a bearing. Rather, an “outer surface” in the sense of the invention, referred to hereinafter simply as a “surface” or [sic], is any planar or rounded “contour” that physically bounds the assembly or component to be monitored. In this sense, any physical surface that demarcates the solid body of the to-be-monitored assembly or component with respect to another body is to be construed as an “outer surface” or “surface” or “contour.” Thus, for example, the radially inwardly disposed circular surfaces of a bearing or slewing ring and all surfaces axially delineating the assembly or component on the top and bottom are always to be construed as “surfaces” or “outer surfaces” or “contours.”

The intermittently, periodically or ongoingly received/detected actual values or actual data representing bearing noise are continually, in the ideal case even continuously, compared with nominal values or nominal data representing bearing noise. These nominal values or nominal data can be deposited or stored either in the (advanced) IT and electronic system, or, alternatively, in the above-described control computer or central computer, but preferably in the at least one evaluation unit. Redundant storage of the data is also conceivable and within the scope of the invention. In a most advantageous embodiment of the invention, however, the nominal values or nominal data are deposited directly, where applicable redundantly, in the memories of intelligent contact sensors.

In a further embodiment of the invention, it is conceivable in particular for the advanced IT and electronic system and the control computer or central computer to form one unit.

As soon as and whenever an existing difference between received or detected actual values or actual data representing the bearing noise and the nominal values or nominal data representing the bearing noise exceeds a given threshold, the aforementioned set limit value, one or more decisions is made, with the aid of the inventive database, regarding the current noise condition of the monitored bearing.

This current noise condition, i.e., all of the actual values or actual data representing bearing noise that are being received/detected at that moment, is intermittently or periodically or ongoingly stored in at least one IT and electronic system, which is thus able to plot a condition model representing the particular current noise condition, as well as past/predicted noise conditions.

The same applies to the secondary sensors: the actual values or actual data representing operating conditions that are received/detected intermittently, periodically or even ongoingly by secondary sensors are continually, in the ideal case even continuously, compared with nominal values or nominal data representing these operating conditions. These nominal values or nominal data can be deposited or stored either in at least one advanced IT and electronic system, or, alternatively, in the above-described control computer or central computer, but preferably in the evaluation unit. Redundant storage of the data is also conceivable and within the scope of the invention.

In a most advantageous embodiment of the invention, however, the nominal values are deposited directly, where applicable redundantly, in the memories of intelligent contact sensors.

As soon as and whenever an existing difference [between] received or detected actual values or actual data regarding temperature condition and/or pressure condition and/or rotation speed condition and/or acceleration condition and/or velocity condition and/or lubricant condition and the corresponding nominal values or nominal data exceeds a given threshold, the respective set limit value, one or more decisions is made, with the aid of the inventive database, regarding the current noise condition of the monitored bearing.

This current operating condition, i.e., all of the actual values or actual data representing operating conditions that are being received/detected at that moment, is intermittently or periodically or ongoingly stored in at least one IT and electronic system, which is thus able to plot a condition model representing the particular current noise condition, as well as past/predicted noise conditions.

This knowledge database, alternatively the advanced IT and electronic system or even the central or control computer, but preferably the at least one evaluation unit, which in the more developed embodiment of the invention is actually an intelligent sensor itself, continually performs a juxtaposition, a so-called comparison or reconciliation, of received/detected actual data or actual values with the stored nominal data or nominal values.

The nominal/actual comparison is used to determine signal, data or value differences. This difference determination takes place, for example, as an internal arithmetic operation. The values or data compared or reconciled in this way, i.e., the differences found between the values or data, are to be construed as comparison or reconciliation data—or “difference data”—and will be referred to in this description as DIFF values or DIFF data.

This difference determination satisfies, for example, the following relation:

DIFFᵢ=ACTUALᵢ−NOMINALᵢ, or: −DIFFᵢ=NOMINALᵢ−ACTUALᵢ,

alternatively:

|DIFFᵢ|=|ACTUALᵢ|−|NOMINALᵢ|=|NOMINALᵢ|−|ACTUALᵢ|

The respective preassigned limit values, both with regard to bearing noise and with regard to the operating conditions, of the elements or components to be monitored, for example of the bearing or slewing ring to be monitored, are to be construed as limit or threshold data or limit or threshold values, referred to in this description as threshold data or threshold values.

The term “threshold value” is to be understood in this description as analogous to the term “limit value.” Limit or threshold values or limit or threshold data are empirical data, which are preferably stored or deposited in the knowledge base or knowledge database and which contain statements regarding permissible maximum condition values, for example maximum permissible frequency, but also maximum permissible temperature, maximum permissible acceleration, maximum permissible pressure, maximum permissible stress, maximum permissible rotation speed, etc.

To clarify the distinction: empirical data, i.e. threshold data or threshold values, can differ from predefined characteristic diagrams and operating patterns—the so-called knowledge data or knowledge values—in that knowledge data or knowledge values contain a large number of threshold data or threshold values. In particular, knowledge data or knowledge values represent a sequence or function of a respective plurality of threshold data or threshold values.

In another embodiment of the invention, these threshold data or threshold values can be deposited or stored in the advanced IT and electronic system, or even in the above-described control computer or central computer. Redundant storage of threshold data or threshold values may also be contemplated, for example temporary or intermediate storage in one or more evaluation units. In the most advantageous embodiment of the invention, however, threshold data or threshold values are continually deposited or stored in the knowledge database or in the advanced IT and electronic system and can be temporarily (buffer-) stored in or outsourced to an evaluation unit or a plurality of evaluation units.

In a further-developed embodiment of the invention, an intelligent sensor itself can also take over the storage of threshold data or threshold values.

Maximum permissible limit or threshold values of the elements or components to be monitored, for example of the bearing or slewing ring to be monitored, are exceeded as soon as, for example, the following relation holds true:

|THRESHOLDᵢ|21 |DIFFᵢ|==TRUE

Maximum permissible limit or threshold values of the elements or components to be monitored, for example of the bearing or slewing ring to be monitored, are undershot, on the other hand, as soon as this exemplary comparison rule becomes applicable:

|THRESHOLDᵢ|>|DIFFᵢ|==TRUE

This monitoring of the permissible threshold or limit values, i.e., the monitoring of the two just-cited rules based on the arithmetic of the described true/false comparison rules, is performed intermittently, periodically or even ongoingly at least in at least one evaluation unit and/or in the advanced IT and electronic system. This takes place, for example, as an internal arithmetic operation. Alternatively, this monitoring of the permissible limit values is also or redundantly performed in at least one central or control computer, possibly in a remotely located control center.

In a further-developed embodiment of the invention, an intelligent sensor itself can actually take over the aforesaid monitoring of the permissible threshold or limit values. This monitoring of the permissible threshold or limit values, i.e., the monitoring of the two just-cited rules based on the arithmetic of the described true/false comparison, is, regardless, stored periodically or ongoingly at least in one evaluation unit and/or in the advanced IT and electronic system, which is thus able to develop a condition model representing the particular current limit value condition, as well as past/predicted limit value conditions.

If the arithmetic of the described true/false comparison leads to observed exceedances of the particular permissible limit value, then an internal counting mechanism assigned this function, and preferably located in the unit where this true/false comparison was performed, is incremented.

This arithmetic operation of incrementing conforms, for example, to the following rule:

IF|THRESHOLDᵢ|<|DIFFᵢ|==TRUE, THEN k=k+1

Alternatively: IF |DIFFᵢ|>|THRESHOLDᵢ|==TRUE, THEN k=k+1

Monitoring of the threshold or limit values for undershooting can be performed, for example, additionally or alternatively. If the arithmetic of this true/false comparison leads to the determination of undershoots of the particular permissible limit value, then an internal counting mechanism assigned this function is also incremented.

It has proven advantageous to use a different counter for the undershoots of the particular threshold/limit value than for the exceedances of the particular permissible limit value. This arithmetic operation of incrementing conforms, for example, to the following rule:

IF |THRESHOLDᵢ|>|DIFFᵢ|==TRUE, THEN m=m+1

Alternatively: IF |DIFFᵢ<|THRESHOLDᵢ|==TRUE, THEN m=m+1

Detected exceedances of the particular permissible threshold or limit value and/or, optionally, in addition or alternatively, also undershoots of the particular permissible threshold or limit value can be continually detected by the system according to the invention, possibly relayed and/or processed further, but in any event stored and tracked to determine their frequency of occurrence. In a particularly advantageous embodiment of the invention, all the detected exceedances of the particular permissible threshold or limit value, and optionally, in addition or alternatively, also undershoots of the particular permissible limit value, are stored in the knowledge database, which, in an advantageous embodiment of the invention, is preferably contained in at least one (advanced) IT and electronic system.

All the arithmetic operations that sequentially follow this threshold or limit value monitoring are preferably performed in this knowledge database or at least in this advanced IT and electronic system.

In this connection: one or more detected exceedances (optionally or alternatively: undershoots) of the particular permissible threshold or limit value can, in a particularly advantageous embodiment of the invention, initiate an automated message or notification to the control computer or central computer, which, for example, can be in a remotely located control center. Preferably, however, this automated message or notification goes to at least one software application operated in or by the inventive condition detection and monitoring system.

In a basic embodiment of the invention, this message or notification is transmitted via a network, for example such as a local network, for instance via LIN bus, MOST bus, Ethernet bus, PROFIBUS, FlexRay bus, or basically via a network based on IEEE Standard 802.

Alternatively or preferably, this message transmission is effected wirelessly, for instance via WLAN, Bluetooth, text messaging, cell phone messaging, etc.

This automated message or notification can preferably, and settably at the discretion of the system operator, depending on the existing bus hardware or the existing communication system, be sent as a wireless or wired email message, as a voice message, as a wireless message, or alternatively as a bussed data field message. Fax message transmissions are also, in principle, conceivable and within the scope of the invention.

If the number of detected exceedances of the particular permissible threshold or limit value (Σ|k|) actually goes above a specific critical number (n_{—crit}), then, in accordance with the inventive idea, a separate warning data message, referred to in the description below as a so-called “MESSAGE/DATA_ALERT” message, goes out to a control computer or central computer, which can be, for example, in a remotely located control center.

The same applies analogously to the case of undershoots of the respective permissible threshold or limit value (Σ|m|) actually a specific critical number (p_{—crit}) [syntax sic], then, in accordance with the inventive idea, a separate warning data message, referred to in the description below as a so-called “MESSAGE/DATA_ALERT” message, goes out to said control computer or central computer.

This separate warning data message can also, possibly solely in earlier, first method step [sic], be transmitted solely internally within the advanced IT and electronic system, for example in order to initiate an evaluation or weighting or condition analysis. Regardless, these separate warning data messages are stored in a storage area provided for this purpose and may be retained for documentation and recordkeeping purposes. In a particularly advantageous embodiment of the invention, this separate warning data message is also issued, possibly additionally, to at least one mobile radio system, for example to at least one portable radio system, for example to at least one radiotelephone or mobile phone.

The routine or operation described in the preceding section is performed according to the teaching of the invention in the advanced IT and electronic system, alternatively or in an additional method step also (once again) in the control computer or central computer. Regardless, this arithmetic operation that initiates this separate warning data message conforms to the following rule, for example:

IF Σ|k|>n_{crit}, THEN MESSAGE/DATA_ALERT

or, analogously:

IF Σ|m|>p_{crit}, THEN MESSAGE/DATA_ALERT

An equivalent or similar separate warning data message is also initiated, independently of the above-described actual number of observed exceedances or undershoots of threshold or limit values, when the chronological order of occurrence of exceedances or undershoots of the particular permissible threshold value or limit value corresponds to an operating pattern, the so-called SAMPLE_{—crit}, that is known to be damaging to components or elements.

To review and clarify:

Empirical data, i.e., threshold data or threshold values, can differ, for example, from predefined characteristic diagrams and operating patterns—the so-called knowledge data or knowledge values—in that knowledge data or knowledge values contain a multiplicity of threshold data or threshold values. Specifically, knowledge data or knowledge values reflect a sequence or function of ever-increasing numbers of threshold data or threshold values.

In one embodiment according to the invention, the knowledge database contains these same knowledge data or knowledge values. These are sequences or functions of “operating patterns known to be damaging to components or elements.”

According to the invention, a plurality, in the ideal case even a multiplicity, of these “operating patterns known to be damaging to components or elements,” preferably up to forty—or more than forty—of these “operating patterns known to be damaging to components or elements,” are stored in the knowledge database.

According to the teaching of the invention, the evaluation of the chronological order of occurrence of detected exceedances or undershoots of the particular permissible threshold or limit value is dependent on the number and quality of the knowledge data or knowledge values stored in the knowledge database, i.e., dependent on the number and quality of the characteristic diagrams and known operating patterns, particularly dependent on the number and quality of the “operating patterns known to be damaging to components or elements” stored in the knowledge database.

It therefore follows that a separate warning data message, a so-called MESSAGE/DATA_ALERT, is issued not only when the specific critical number (n_{—crit}, ) of detected limit value exceedances is surpassed, but also when the chronological order of occurrence (F_{{ }}) or the time sequence of occurrence, referred to exemplarily in the present context as (F{|THRESHOLDᵢ|}), of a plurality of detected exceedances or undershoots of a permissible threshold or limit value corresponds to an “operating pattern known to be damaging to components or elements.” A separate warning data message, a so-called MESSAGE/DATA_ALERT, is issued under these circumstances, as well.

Here again, it is the case, for example, that this separate warning data message is initially transmitted solely internally in the advanced IT and electronic system, for example so as to initiate an evaluation or weighting or condition analysis. In this case, here again, these separate warning data messages are stored in a storage area set aside for this purpose, and may be retained for documentation and recordkeeping purposes. In a particularly advantageous embodiment of the invention, this separate warning data message is also issued, possibly additionally, to at least one mobile radio system, for example to at least one portable radio system, for example to at least one radiotelephone or cellular phone.

In a very specialized embodiment of the condition detection and monitoring system, all the MESSAGE/DATA_ALERT messages or notifications that are issued can also be transmitted in encrypted or encoded form, so that only corresponding receiving stations that know the decryption or decoding key can receive and decode or interpret the MESSAGE/DATA_ALERT messages or notifications.

In a yet more distant embodiment of the inventive condition detection and monitoring system, the MESSAGE/DATA_ALERT messages or notifications that are issued can also be designed to be compatible with a so-called WEB 2.0 media network, so that corresponding WEB 2.0 receiving stations can receive and decode or interpret the MESSAGE/DATA_ALERT messages or notifications.

This arithmetic operation that initiates this separate warning data message, the so-called MESSAGE/DATA_ALERT, satisfies, for example, the following rule:

IF F{|THRESHOLDᵢ|}==SAMPLE_{—crit}, THEN MESSAGE/DATA_ALERT.

In a future embodiment of the invention, it will be possible for the number and quality of the “operating patterns known to be damaging to components or elements” stored in the knowledge database to go through a self-learning process. This means that as a result of more extensive arithmetic operations in the control computer or central computer or in the (advanced) IT and electronic system, the number and quality of the knowledge data or knowledge values stored in the knowledge database, i.e. the number and quality also of the “operating patterns known to be damaging to components or elements,” will be increased step by step or continuously and in an improved manner.

The ultimate goal of this particularly advantageous future embodiment of the invention is to create a self-learning and self-optimizing knowledge base that continuously improves the “operating patterns known to be damaging to components or elements,” sharpens them as appropriate, and autonomously increases their number and quality.

The manner of operation of the inventive condition detection and monitoring system will now be described again briefly with reference to the example of a wind energy main bearing. In the following description, the aforesaid “operating pattern known to be damaging to components or elements” will be referred to as a noise sample SAMPLE_{—crit I} stored in the knowledge database.

List of Reference Numerals:

| | | | |
|---|---|---|---|
| K | Bearing or slewing ring/ | 100 | Condition detection and |
| | assembly or component | | monitoring system |
| 80 | Central or control computer | A | Attachment or incorporation |
| | | | site for contact sensor |
| 50 | IT and electronic system | B | Attachment or incorporation |
| | | | site for secondary sensor |
| WB | Knowledge database | E | Evaluation unit or evaluation |
| | | | module |
| L | Wire connection: discrete | LW | Wireless connection: |
| | line/network line/bus line | | Bluetooth connection/WLAN |
| | | | connection/radio link |
| F/V | Amplification or filtering | 60 | Filter module or amplifier |
| | | | module |
| 1 | Surface or contour | 2 | Noise/sound/mechanical wave |
| 3 | Contact sensor/contact | 4 | Signal/datum/value |
| | sensor system | | |
| 5 | Signal/datum/value | 6 | Microcontroller |
| 7 | Membrane | 8 | Electrode |
| 9 | Piezoelectric element | 10 | Permanent magnet/iron |
| 11 | Inductive element, coil | 12 | Voltage supply |
| 13 | Resistance/network | 14 | Signal/datum/value |
| 15 | Microprocessor | 16 | Control unit |
| 17 | Arithmetic unit | 18 | Memory |
| 19 | Interface | 20 | Secondary sensor/secondary |
| | | | sensor system |
| 21 | Housing | 22 | Interface |
| 23 | Interface | 24 | Interface |
| 25 | Bus system/system bus | 26 | Housing |

The condition detection and monitoring system (100) according to the invention, functioning particularly on the basis of the above-described method steps or routines, detects, for example, bearing damage, such as a seizing-induced pocket or a chipped edge, at an internal location in a wind energy main bearing, since this damage causes cyclically or periodically recurring, or even continuous, interference noise, disrupting the smooth operation of said wind energy main bearing, that is detected/received by the contact sensors.

According to the method of the invention, as soon as this noise exceeds the particular maximum permissible limit values, it is detected, for example, by the evaluation unit and is passed along internally, i.e., for example, within the advanced IT and electronic system.

The above-described separate warning data message is issued as soon as the number of exceedances of a particular maximum permissible limit value assumes a critical number—or as soon as the chronological [noun missing] of this plurality of detected limit value exceedances corresponds to an “operating pattern known to be damaging to components or elements” or a SAMPLE_{—crit i}.

To be able to recognize when, during the operation of the exemplarily cited wind energy main bearing, an “operating pattern known to be damaging to components or elements” is present, a comparison or reconciliation of the actual conditions that are, in fact, present with the nominal conditions that can be retrieved from the relevant memory is performed at least periodically or, in the best case, even ongoingly.

By periodically or ongoingly detecting bearing noises using the contact sensor system attached to this exemplarily cited wind energy main bearing and subsequently checking these noises for limit value exceedances or undershoots, the inventive system can determine agreement with the actually detected/received noise sample and the noise sample SAMPLE_{—crit} stored in the knowledge database, that a seizing-induced pocket or a chipped edge is present [syntax sic]. Immediately after this detection, a corresponding separate warning data message is transmitted to the proper location, for example the remotely located control center.

The computer processing of detected exceedances can take place here by remote data transmission via radio, WLAN, UMTS or cellular communication network, local network (LAN), Ethernet bus system, PROFIBUS, TCP/IP, etc.

Thus, for example, the conditions of the monitored components of a wind energy system can also be observed from a remotely located (far distant) control center, in which, for example, the aforesaid control computer or central computer is set up.

Data analyses relating to past/prior noise conditions, or also past/prior limit value conditions, or also past/prior operating conditions, can thus constantly be initiated and carried out via a remotely located control center that may be some distance away.

The particular decision as to whether an “operating pattern known to be damaging to components or elements” is, in fact, truly present in practice can be made with a given probability in the initial levels of expression of the invention.

The final decision as to whether an “OK BEARING” or a “NOT OK BEARING” is present is therefore made can [sic] on the basis of a (statistical) probability statement that is calculated in the advanced IT and electronic system, using the knowledge database corresponding to the invention.

Particular features, characteristics, advantages and effects on the basis of the invention will become apparent from the following description of a preferred embodiment of the invention and other advantageous embodiments of the invention and by reference to the drawings. Therein:

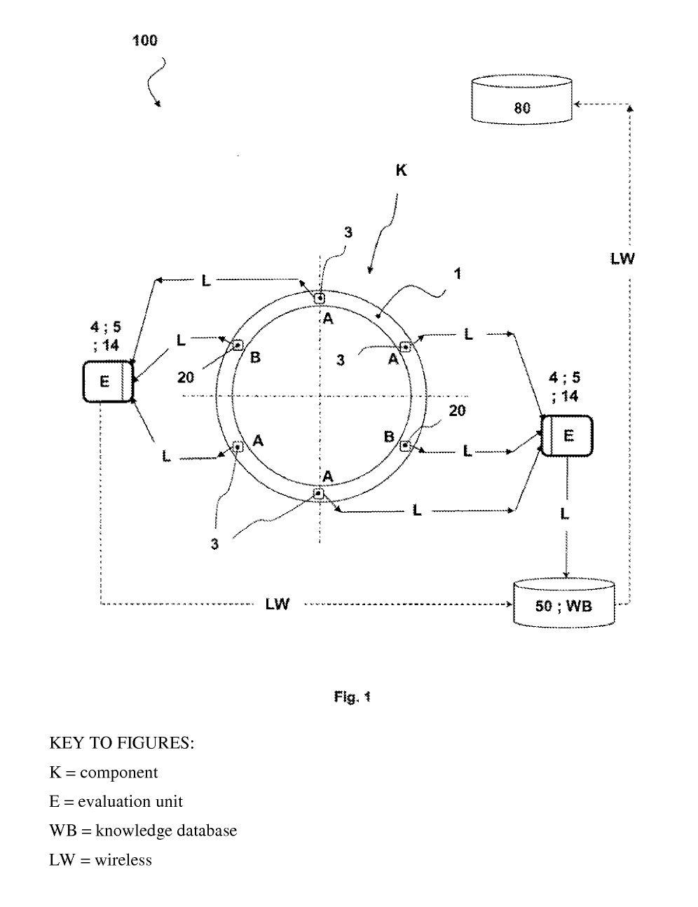

FIG. 1 shows an exemplary embodiment of the condition detection and monitoring system, indicating a monitored bearing or a monitored slewing ring provided with four contact sensors and two secondary sensors, in schematic representation, comprising two evaluation units connected to an IT system (containing the knowledge base). This IT system is wirelessly connected to a remote central or control computer.

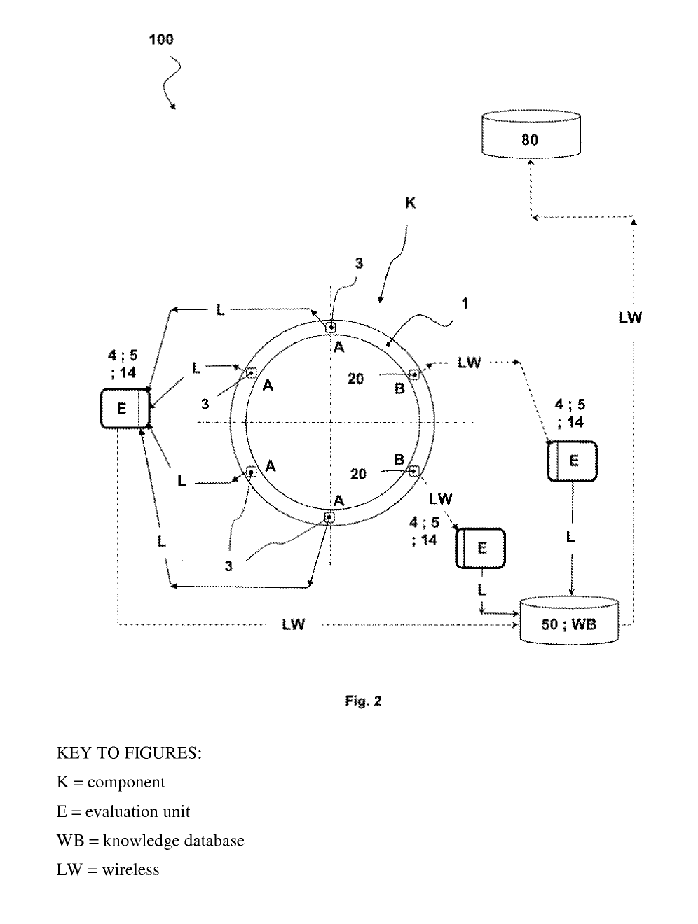

FIG. 2 shows an exemplary embodiment of the condition detection and monitoring system, indicating a monitored bearing or a monitored slewing ring provided with four contact sensors and two secondary sensors, in schematic representation, comprising three evaluation units connected to an IT system (containing the knowledge base). This IT system is wirelessly connected to a remote central or control computer.

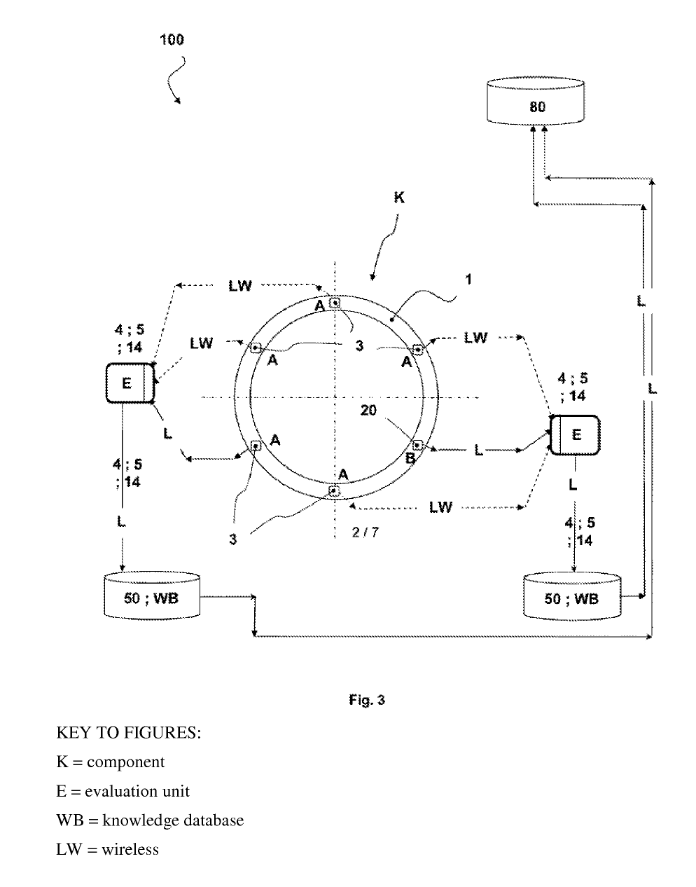

FIG. 3 shows an exemplary embodiment of the condition detection and monitoring system, indicating a monitored bearing or a monitored slewing ring provided with five contact sensors and one secondary sensor, in schematic representation, comprising two evaluation units, each connected to a respective IT system (containing the knowledge base). Each of these IT systems is wirelessly connected to a remote central or control computer.

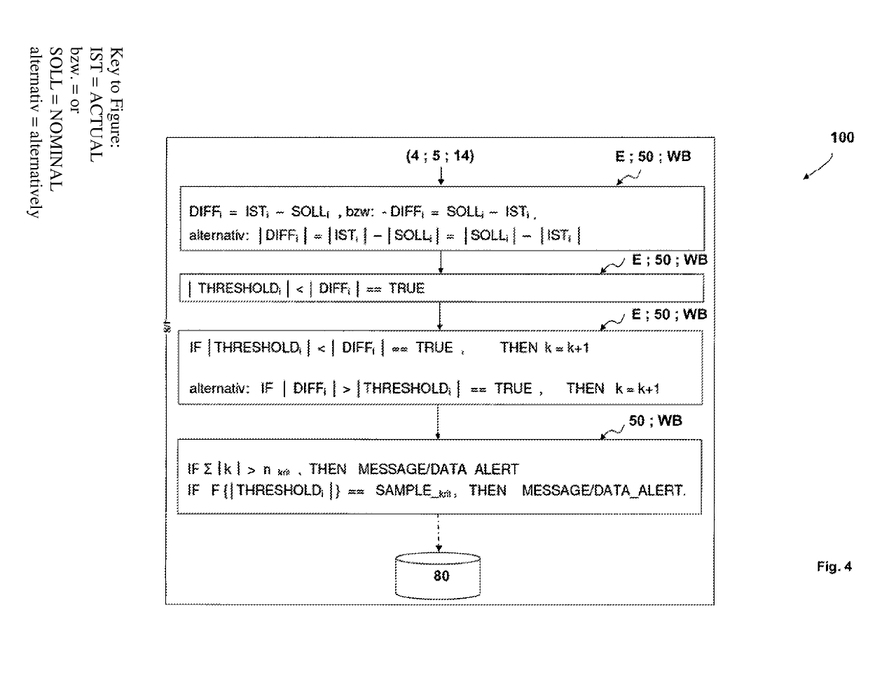

FIG. 4 shows an exemplary sequence of the method for detecting and monitoring a bearing or a slewing ring, representing measurement-value detection and difference determination, comparison of threshold values, incrementation of the counter if threshold values are exceeded, and also the generation of warning messages and transmission of these warning messages to the central or control computer.

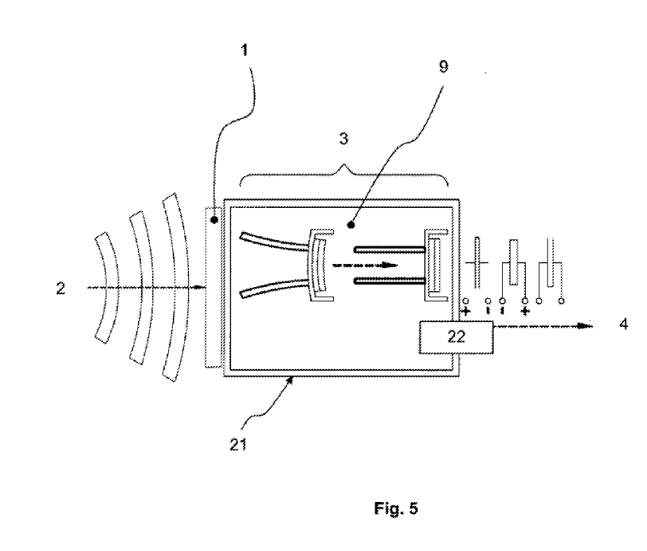

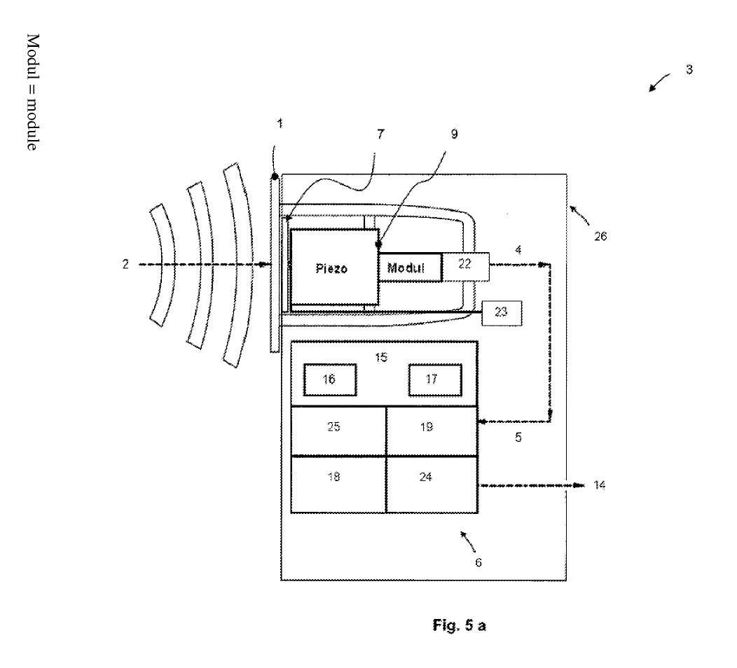

FIG. 5 shows by way of example a contact sensor based on the piezoelectric principle and mounted on the surface of the assembly or component to be monitored, indicating the mechanical change inside the piezoelectric core and the principle of electrical signal generation.

FIG. 5a shows by way of example another contact sensor based on the piezoelectric principle, but as an intelligent sensor, i.e., with a connected microcontroller and associated modules (interfaces, arithmetic unit, control unit, housing, etc.).

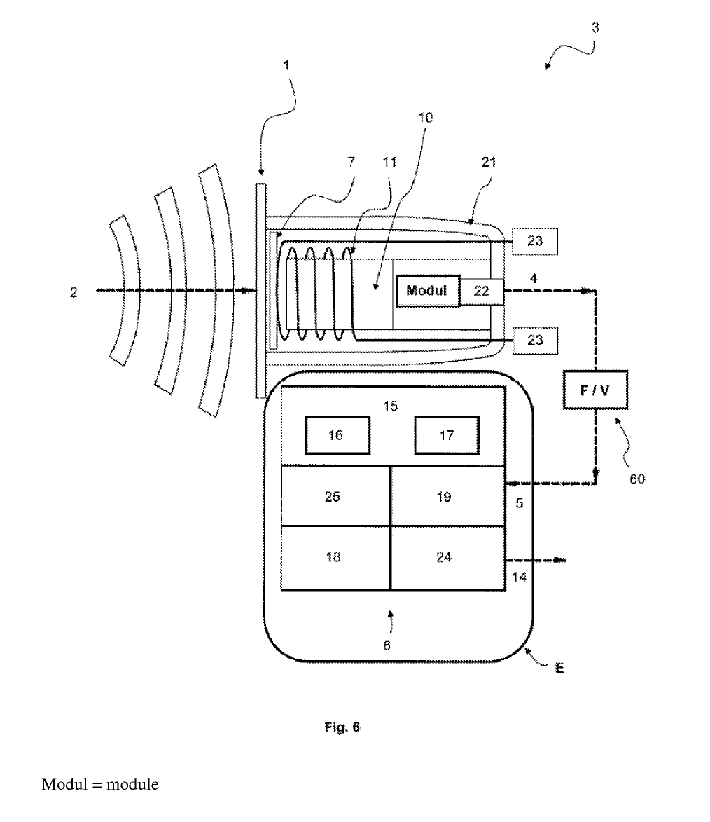

FIG. 6 shows by way of example a contact sensor based on the inductive principle, here as an intelligent sensor, i.e., with a connected microcontroller and associated modules (interfaces, arithmetic unit, control unit, housing, etc.), and further comprising an amplification and possibly filtering module.

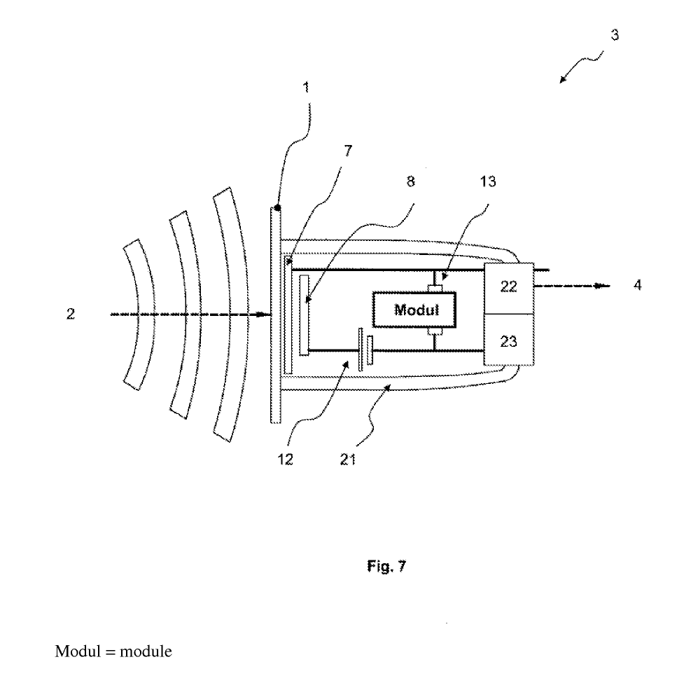

FIG. 7 shows by way of example a contact sensor based on the capacitive principle.

The configuration of the system according to the invention in the immediate vicinity of the element to be monitored, for example the wind energy main bearing (K), will now be described:

FIG. 1 and FIG. 3 show the condition detection and monitoring system (100) for the at least intermittent, possibly periodic, preferably even ongoing (value-, signal-or data-based) detection and monitoring of condition parameters of at least one assembly (K) or component, or even of sub-elements of said assembly or component, particularly at least of a bearing or slewing ring, for example in or on a wind turbine, with four contact sensors (3) that are attached to or incorporated into said assembly or component (K) and each of which is disposed directly at or in an incorporation site.

FIGS. 1 and 2 show, by way of example, four of these sites (A) on a planar or rounded surface (1) or contour of the bearing (K). These sensors (3) are usefully installed by screwing/insertion/welding/brazing/adhesive bonding or clamping, possibly to a nose ring or support ring or retaining ring of the bearing. FIG. 3 shows five of these sites (A), each accommodating one contact sensor (3).

Not shown in the figures but worth mentioning is the fact that the various incorporation sites (A; B) can spatially overlie one another.

To pass along signals/data/values (4; 5; 14), each contact sensor (3) is directly or indirectly connected by value-, signal-or data-based technology to at least one evaluation unit (E) or evaluation module (E). The same applies to secondary sensors (20).

Each of these evaluation units (E) is preferably an electronic evaluation unit, which, using value-, signal-or data-based technology, is able to receive the signals/data/values (4; 5; 14) from the contact sensors (3) or secondary sensors (20) and transmit them, possibly with prior amplification or filtering (60; F/V). The communication or information exchange or information flow is conducted with an IT and electronic system (50), or, alternatively, with a plurality of such IT and electronic systems.

It is conceivable and within the scope of the invention that all contact sensors (3) send signals/data/values (4; 5; 14) to a specific, first evaluation unit (E), and all secondary sensors send their signals/data/values (4; 5; 14) to another, second evaluation unit (E).

FIGS. 1, 2 and 3 have in common the fact that the transmission of signals/data/values (4; 5; 14) can be effected either by wire (L), for example via discrete lines (L) or via local networks based on IEEE Standard 802, but preferably wirelessly (LW). Wireless transmission requires, in particular, separate voltage or power supplies for those devices that are not or will not be connected to the power grid.

FIG. 4 illustrates an exemplary sequence of the method for detecting and monitoring the exemplary wind turbine bearing (K), showing, from top to bottom, the detection of signals/data/values (4; 5; 14) with subsequent determination of differences DIFFᵢ, followed by a limit value or threshold value comparison, incrementation of a counter (k=k+1) if a threshold is exceeded, and also the generation of warning messages or the initiation of warning data messages (MESSAGE/DATA_ALERT) and subsequent transmission of these warning messages to the central or control computer (80).

FIG. 5 shows by way of example a contact sensor (3) based on the piezoelectric principle and mounted on the surface (1) of the bearing (K) to be monitored, characterizing the mechanical change inside the piezoelectric core (9), and the principle of the electrical signal generation (4) taking place at the sensor interface (22). FIG. 5a, on the other hand, schematically describes a contact sensor (3) based on the just-described piezoelectric principle, but in the preferred embodiment as an intelligent sensor, i.e., with a connected microcontroller (6) and associated modules (interfaces, arithmetic unit, control unit, housing, etc.).

FIG. 6 shows a contact sensor (3) based on an inductive principle, also as an intelligent or smart sensor, i.e., with a connected microcontroller (6) and associated modules such as a processor (15), interfaces (22; 23; 19; 24), arithmetic unit (17) or control unit (16), housing (21), and further comprising an amplifying and possibly filtering module (F/V; 60). Characteristic features of this inductive sensor (3) are the membrane (7) that can be incorporated into or mounted on the surface or contour (1), the permanent magnetic element or module (10), the inductive or coil element (11).

As in the case of all contact sensors (3) according to the invention, noise/vibrations/sound waves (2) strike this surface (1) and are received or detected by the sensor (3), particularly as a result of the micromechanical realization of the sensing elements in the sensor (3).

FIG. 7 shows by way of example a contact sensor based on the capacitive principle, containing a network module (13) integrated into the sensor housing (21) and an electrode (8), several interfaces, for example for linking the sensor (3) to a wire-based (L) bus system or, alternatively, to a wireless communication device.

Both FIG. 5a and FIG. 6 show the sensor as an intelligent sensor, i.e., having at least one memory (18) for storing data or values, for example nominal and/or threshold data or values, or also other data or values that may be useful for the method. FIG. 5a also depicts a shared housing (26), i.e., the sensor (3) and is connected [sic] to a microcontroller (6).

In practice, for example, specific contact sensors (3) are attached to or incorporated into the bearing or slewing ring (K) to be monitored, or the element or bearing or element segment (K) to be monitored, for example at a plurality of locations (A) on the bearing, preferably each at a respective defined location (A) per bearing segment or element segment. The contact sensors (3) and/or the secondary sensors (20) can be fixed in or at the incorporation site (A; B) with the aid of holding devices such as installation, mounting or retaining plates.

It has proven advantageous particularly if these contact sensors (3) are adjacent to and nearly equidistant from one another. If, for example, three contact sensors are used to monitor a bearing ring (K), then the contact sensors (3) are attached to the bearing ring (K) to be monitored at a spatial interval of 120° from each other. On the other hand, if, for example six or eight contact sensors are used for monitoring, then these are attached to the bearing ring (K) to be monitored at intervals of 60° or 45° from each other.

Not merely single contact sensors (3) are attached to the bearing ring (K) to be monitored in this case, but, alternatively, a contact sensor network can be attached to the bearing ring, for example in the form of a self-adhesive or adhesive-bondable mat. This “sensor mat” or “sensor network” contains a mesh or net composed of a great many discrete contact sensors, which are nevertheless electrically connected or connectable to one another. To permit simplified installation on the bearing ring, this “sensor mat” can be adapted to the contour of the bearing ring to be monitored. However, it is of heightened importance in this case that no load-bearing parts of the bearing ring (K), such as screws, nuts, mounting screw drill holes, screw holes, lubrication inlet and outlet bores, etc., be in contact with or covered by the “sensor mat.”

Finally, this “sensor mat” or “sensor network” can be mounted by physical methods on the component to be monitored, for example on the bearing ring (K) to be monitored or on the surface (1) of the slewing ring to be monitored. In a distant embodiment and further development of the invention, it is also conceivable to use such a “sensor mat” or “sensor network” made by production methods used in the fabrication of microelectronic components or integrated circuits, for example sputtering or CVD. Thus, It is also conceivable within the scope of the invention to use contact sensors (3) that thus contain semiconductor-based circuits. The production of such microelectronic circuits is effected by semiconductor technology methods (production of the components on a substrate and, in the case of monolithic circuits, installing wiring) and assembly and interconnection technology. Thin-film technology methods can also be used here.

The contact sensors (3) according to the invention are to be understood, both in general and in the example of the wind energy main bearing, as noise receivers or noise detectors, and can, for example, detect/receive noise throughout the structure-borne noise frequency band, for example in the range of 0.01 Hz to >20 kHz (i.e., the entire range of sound audible to the human ear), but also well beyond, for example in the megahertz range.

The range 0.1 Hz to >1.0 kHz is particularly important for the detection of noises and their reflection and diffraction in the monitoring of bearing and slewing ring structures; assemblies and components, for example, that receive/detect noises generated by the entire system (such as rotor imbalances and tower bending frequencies in the case of a wind energy system) should be monitored in the frequency range between 0.1 Hz and approximately 10 Hz. In contrast, for example, elements and components that, for example, receive/detect the vibration of rapidly moving machine parts should be monitored in the frequency range between 10 Hz and approximately 1.0 kHz.

The speed of sound in metal materials—and thus, for example, in the steel used in bearing construction—can basically range from 2.5×1000 m/s to 6.5×1000 m/s, depending on the composition and/or alloying and the temperature of the metal. The speed of sound is generally lower at low temperatures than at high temperatures.

The contact sensors (3) attached to the wind energy main bearing (K) can be, for example, piezoelectric sensors, are each in permanent physical contact with one of the bearing rings, and detect the changes in electrical potential caused by the structure-borne sound at the respective incorporation site. The structure-borne sound occurs during the operation of the bearing (L) or slewing ring. One advantage of using piezoelectric contact sensors is the relatively high usability of the detected signals, that is, the detected signals or voltages do not require much filtering in subsequent steps.

Inductive or capacitive sensors can also be used alternatively or additionally here as contact sensors.

In a very broadly construed/alternative embodiment of the invention, eddy current sensors can also be used as contact sensors (3), if appropriate. With such eddy current sensors, an alternating field in the electrically conductive object (the bearing) generates eddy currents, which result in Joule losses. Ultrasonic sensors can also, in principle, be used as contact sensors. In particular, even relatively small defects can be detected precisely with ultrasound sensors. Noise sensors can also be used as contact sensors. Noise sensors are to be particularly recommended for monitoring slewing rings and bearings in wind energy systems.

In a further embodiment of the invention, the contact sensors (3) are connected to the to-be-monitored assembly (K) or component not directly, but indirectly, for example via a support apparatus attached to, preferably welded or screwed to, said assembly or component. The particular mounting location of such a support apparatus then defines an attachment or incorporation site (A) for the respective contact sensor. Delicately constructed or compartmentalized seismometer sensors can be used—possibly additionally—to detect structure-borne sound, as well, but the relatively long-wavelength components thereof.

Similarly, in another embodiment of the invention, one or more secondary sensors (20) are connected to the to-be-monitored assembly or component not directly, but indirectly, for example via a support apparatus attached to, preferably welded or screwed to, said assembly or component. The particular mounting location of such a support apparatus then defines the attachment or incorporation site (B) for the respective secondary sensor.

As a rule, and based on the above example of the wind energy main bearing (K), rolling elements, for example, generate corresponding rolling noises during their rolling or sliding movement in the raceway system. The basic principle here is the difference in propagation velocity between the longitudinal and transverse waves and their reflection and diffraction from the bearing structures. These rolling noises appear as characteristic frequency components in the structure-borne sound frequency band. The acoustical properties of the bearing components and the technical condition (bearing wear, chips in the bearing, too little lubricant, too much lubricant, cyclic knocking at certain positions, etc.) of the bearing or the slewing ring can be thus be detected. Crack formation and pitting can also be detected, sometimes many operating hours before these cracks or defects in the bearing or slewing ring lead to a material failure that would make it necessary to shut down not just the bearing or slewing ring, but also the entire system attached to it, for repairs.

Sensors having secondary functions (20) can be, for example, sensors for receiving or detecting condition data relating to temperature, pressure, rotation speed, acceleration and lubrication. Positions can also be received or detected. Commonly available temperature condition, pressure condition, rotation speed condition, acceleration condition or lubricant condition sensors or incremental sensors can be used for these purposes. All of these sensors having secondary functions (20) can be mounted in or on the element (K) to be monitored, to supply flanking values regarding the bearing or bearing segment that is to be metrologically detected and monitored.

Both the evaluation of the data/values/signals (4; 5; 14) acquired from the contact sensors (3) and the evaluation of the data/values/signals (4; 5; 14) acquired from the secondary function sensors (20) take place at least periodically or ongoingly, for example even constantly in real time. It is therefore within the scope of the invention for the IT and electronic system (50) referred to above to be real-time-capable. One approach that has proven particularly helpful here within the scope of the invention is a real-time-capable controller or a real-time-capable control computer in the immediate vicinity of the element (K) to be monitored or the component (K) to be monitored, for example in the immediate vicinity of the bearing (K) or slewing ring (K) to be monitored. However, it is also conceivable according to the invention to use such a controller or control computer that is present in the system where the bearing or the slewing ring is installed, for example in the hub, the nacelle or the tower of a wind energy system.

In the most advantageous realization of the invention, both the contact sensors (3) and the secondary sensors (20) in the above example are to be embodied as intelligent sensor modules, i.e., each with its own microcontroller (6), including a small electronic data storage unit (18). The supply of electricity for each individual sensor (3; 20) can then, for example, come from a power supply that is already present in the vicinity of the bearing, or, for example, from readily installed solar or photovoltaic cells, for example adhesive solar or photovoltaic cells, which of course are positioned so that they are exposed to solar radiation, but nevertheless close to the sensor concerned.

The evaluation of the data/values/signals (4; 5; 14) acquired from the contact sensors (3) and/or secondary sensors (20) always takes place in at least one evaluation unit (E) external to the bearing, for example connected to the sensors via electrical lines. Thus, the contact sensors (3) and/or the secondary sensors (20) are electrically connected to the evaluation units or the evaluation unit by electrical lines (L). In an alternative embodiment, the connection between the contact sensors (3) and secondary sensors (20) and the evaluation unit(s) (E) is made without a wire-based, physical connection to the at least one evaluation unit, i.e., wirelessly, for example via radio data transmission (LW). In that embodiment, wireless data communication prevails between the at least one evaluation unit (E) and each sensor (3; 20) associated with the bearing being monitored.

In a further alternative embodiment, the individual contact sensors (3) and/or secondary sensors (20) are interconnected by a set of signal buses. For example, but not limited to: CAN bus, LIN bus, etc. It is recommended, in this embodiment, that the individual sensors (3; 20) draw their own electrical power via the buses. It is further recommended in this embodiment that each of the individual sensors have its own internal memory (18).

The ultimate evaluation and categorization of the monitored element or component, for example of the aforesaid wind energy main bearing, as to whether a functional element (K) or component (K) is present, this being identified for purposes of simplification as “OK bearing,” or whether a non-functional element or component is present, this being identified for purposes of simplification as “NOT OK BEARING,” is always made with the assistance of the knowledge database (WB), as described below: the knowledge database (WB) has in its internal memory a plurality of “operating patterns known to be damaging to components or elements,” which are stored in the knowledge database as noise samples (SAMPLE_{—crit i}).

The method according to the invention is able, with a given probability, to recognize, to distinguish, up to forty, or possibly even more, of the “operating patterns known to be damaging to components or elements.” The following list gives a thorough representation of the possible “operating patterns known to be damaging to components or elements”:

SAMPLE_{—crit 1}=f (wear of bearing),

SAMPLE_{—crit 2}=f (severe wear of bearing),

SAMPLE_{—crit 3}=f (chips in bearing),

SAMPLE_{—crit 4}=f (too little lubricant in bearing),

SAMPLE_{—crit 5}=f (crack formation in raceway system),

SAMPLE_{—crit 6}=f (severe crack formation in raceway system),

SAMPLE_{—crit 7}=f (pitting in raceway system),

SAMPLE_{—crit 8}=f (seizing or immobilization of bearing),

SAMPLE_{—crit 9}=f (edge chipping),

SAMPLE_{—crit 10}=f (bearing deformation),

SAMPLE_{—crit 11}=f (severe bearing deformation),

SAMPLE_{—crit 12}=f (damage to rolling elements),

SAMPLE_{—crit 13}=f (loss of rolling elements),

SAMPLE_{—crit 14}=f (aging of lubricant),

SAMPLE_{—crit 15}=f (severe aging of lubricant),

SAMPLE_{—crit 16}=f (elevated iron content in lubricant),

SAMPLE_{—crit 17}=f (decrease in bolt preload),

SAMPLE_{—crit 18}=f (severe loss of bolt preload),

SAMPLE_{—crit 19}=f (elastic deformation of raceway system),

SAMPLE_{—crit 20}=f (water in bearing),

SAMPLE_{—crit 21}=f (dimpling or scoring),

SAMPLE_{—crit 22}=f (cage wear),

SAMPLE_{—crit 23}=f (cage fracture),

SAMPLE_{—crit 24}=f (fracture of spacers),

SAMPLE_{—crit 25}=f (seal leakage),

SAMPLE_{—crit 26}=f (jamming of seal into raceway system),

SAMPLE_{—crit 27}=f (signs of impending tooth fracture),

SAMPLE_{—crit 28}=f (tooth fracture),

SAMPLE_{—crit 29}=f (wear fracture of bearing),

SAMPLE_{—crit 30}=f (bearing defect due to abrupt blade adjustment),

SAMPLE_{—crit 31}=f (bearing defect due to lightning strike),

SAMPLE_{—crit 32}=f (segmental chipping in bearing),

SAMPLE_{—crit 33}=f (segmental chipping in cage),

SAMPLE_{—crit 34}=f (partial tearing away of a blade),

SAMPLE_{—crit 35}=f (complete tearing away of a blade),

SAMPLE_{—crit 36}=f (damage to main drive shaft),

SAMPLE_{—crit 37}=f (fracture of main drive shaft),

SAMPLE_{—crit 38}=f (high lubricant pressure in bearing),

SAMPLE_{—crit 39}=f (low lubricant pressure in bearing),

SAMPLE_{—crit 40}=f (total loss of bolt preload)

For example, the “operating pattern known to be damaging to components or elements” SAMPLE_{—crit 1} can indicate an operating pattern that implies wear of the bearing; for example, the “operating pattern known to be damaging to components or elements” SAMPLE_{—crit 3} can indicate an operating pattern that implies chips in the bearing; for example, the “operating pattern known to be damaging to components or elements” SAMPLE_{crit 4} can indicate an operating pattern that implies too little lubricant in the bearing; for example, the “operating patterns known to be damaging to components or elements” SAMPLE_{—crit 4} and SAMPLE_{—crit} can indicate different degrees of severity of the operating pattern that imply more or less advanced crack formation in the raceway system; for example, the “operating pattern known to be damaging to components or elements” SAMPLE_{—crit 7} can indicate an operating pattern that implies pitting in the raceway system, etc.

On this basis, the particular decision as to whether a detected “operating pattern known to be damaging to components or elements” is, in fact, truly present in practice can always be made with a given probability by the condition detection and monitoring system (100).

The final decision as to whether the element (K), for example the wind energy main bearing, that is being periodically or ongoingly monitored by the condition detection and monitoring system (100) is recognized as an “OK BEARING” or a “NOT OK BEARING” is always made on the basis of a (statistical) probability statement calculated in the advanced IT and electronic system (50) by accessing the knowledge database (WB) according to the invention.

In a further embodiment of the invention, on each occurrence of one or more “operating patterns known to be damaging to components or elements,” one or more error memory entries, so-called “error codes” or “error diagnosis codes,” are stored in the condition detection and monitoring system (100) according to the invention. Each of these “error codes” or “error diagnosis codes” describes only a respective one of the above-cited “operating patterns known to be damaging to components or elements.” In the most fully realized embodiment of the invention, the inventive condition detection and monitoring system is able to distinguish up to forty different “error codes” or “error diagnosis codes.”

In the particularly advantageous future embodiment of the invention, the knowledge base (WB) [words missing] probability statement regarding situations recognized as “operating patterns known to be damaging to components or elements” is to be improved, possibly sharpened, and autonomously increased in number and quality, by self-learning and self-optimization mechanisms.

1. A condition detection and monitoring system for the at least intermittent, possibly periodic, preferably even ongoing, value-, signal-or data-based detection and monitoring of condition parameters of at least one assembly or component, for example of a bearing or a slewing ring in or on a wind turbine, comprising:
at least one, preferably more than two, contact sensors which are attached to or incorporated into said assembly or component,
and which can preferably be directly or indirectly attached or incorporated at or in an incorporation site located, for example, on a planar or rounded surface or a contour of said assembly,
and which can usefully be attached or incorporated by screwing/insertion/welding/brazing/adhesive bonding or clamping, possibly to a nose ring or a support ring or retaining ring of a large rolling bearing,
and, alternatively, which can be attached or incorporated at or on at least one radial or axial inner or outer surface of a blade bearing, main bearing or tower bearing of a wind turbine,
wherein the at least one contact sensor is directly or indirectly connected or connectable to at least one evaluation unit or evaluation module, particularly to an electronic evaluation unit, by value-, signal-or data-based technology for the purpose of relaying signals/data/values,
wherein optionally at least one secondary sensor, which is not a contact sensor, also is directly or indirectly connected or connectable to said evaluation unit by value-, signal-or data-based technology for the purpose of relaying signals/data/values.

2. The condition detection and monitoring system as in claim 1, characterized in that
signals/data/values, possibly having undergone prior amplification or filtering, can be received with the aid of value-, signal-or data-based technology by at least one IT and electronic system, alternatively by a plurality of IT and electronic systems.

3. The condition detection and monitoring system as in claim 1, characterized in that
the transmission of signals/data/values is effected either by wire, for example via discrete lines or via local networks based on IEEE Standard 802, but preferably wirelessly.

4. The condition detection and monitoring system as in claim 3, characterized in that
the transmission of signals/data/values is effected either on the basis of WLAN or Bluetooth standards, alternatively via field bus system(s), possibly with the use of transmitting and receiving units for PROFIBUS, CAN bus, MOST bus, LIN bus, FlexRay bus or Ethernet bus systems.

5. The condition detection and monitoring system as in claim 1, characterized in that
at least one contact sensor is embodied as a piezoelectric sensor, alternatively is embodied as an inductive sensor, also alternatively is embodied as a capacitive sensor, wherein, possibly additionally, at least one additional secondary sensor can be attached or incorporated directly or indirectly at or in an incorporation site at or on a surface or contour of said assembly or component, wherein a plurality of incorporation sites can spatially overlie one another.

6. The condition detection and monitoring system as in claim 1, characterized in that
at least one contact sensor or secondary sensor is embodied as an intelligent sensor, comprising at least one memory that is preferably connected to a microcontroller in a shared housing.

7. The condition detection and monitoring system as in claim 1, characterized in that
the at least one contact sensor and/or the secondary sensor comprises at least three of the following modules or components: a microprocessor, a control unit an arithmetic unit, an interface, a voltage supply, a membrane, an electrode or a piezoelectric element or an inductive element or a resistor or a permanent magnet/iron, and possibly further comprises a system bus, preferably wherein at least one of the contact sensors contacts at points or rests areally against the surface or contour of the assembly or component by a membrane.

8. The condition detection and monitoring system as in claim 1, characterized in that
the at least one contact sensor and/or secondary sensor is enclosed by a housing that is attached or incorporated directly or indirectly to the assembly or component at the incorporation site for said contact and/or secondary sensor, possibly with the aid of a holding device or devices such as installation, mounting or retaining plates.

9. The condition detection and monitoring system as in claim 2, characterized in that
the at least one IT and electronic system comprises or contains a knowledge database,
alternatively is connected or connectable by value-, signal-or data-based technology to an external knowledge database,
wherein said knowledge database contains empirical data such as threshold or limit values or so-called threshold data or threshold values,
preferably also/or contains characteristic diagrams and operating patterns or so-called knowledge data or knowledge values, each of which may possibly represent a sequence or function of a plurality of threshold or limit values,
ideally, wherein some specific knowledge data or knowledge values constitute or identify sequences or functions of “operating patterns known to be damaging to components or elements,” each of which, for example, is denoted as SAMPLE_{—crit},
wherein the at least one IT and electronic system, moreover, is or can be connected by value-, signal-or data-based technology to a central or control computer, which may possibly be installed in spatial separation from the assembly or component, for example is installed more than approximately 5 meters away, preferably is installed many kilometers away.

10. A method for the at least intermittent or periodic, preferably even ongoing, detection and monitoring of condition parameters of at least one assembly or component, for example of a bearing or a slewing ring in or on a wind turbine, comprising:
direct or indirect transmission of signals/data/values from at least one contact sensor, possibly additionally at least one secondary sensor, to at least one evaluation unit or to an IT and electronic system, alternatively to an interconnected combination of a plurality of (advanced) IT and electronic systems.

11. The method for the at least intermittent or periodic, preferably even ongoing, detection and monitoring of condition parameters of at least one assembly or component as in claim 10,
characterized in that
the direct or indirect transmission of signals/data/values takes place by wire, for example via discrete lines or via at least one network based on IEEE Standard 802, preferably or alternatively also takes place wirelessly, for example on the basis of the WLAN or Bluetooth standard, or via system bus or field bus system(s), possibly takes place with the use of transmitting and receiving units for PROFIBUS, or CAN bus, or MOST bus, or LIN bus, or FlexRay bus or Ethernet bus systems.

12. The method for the at least intermittent or periodic, preferably even ongoing, detection and monitoring of condition parameters of at least one assembly or component as in claim 10,
characterized in that
in one method step, preferably for purposes of difference determination, nominal data are compared with actual data, for example according to the arithmetic operation:
DIFFᵢ=ACTUALᵢ−NOMINALᵢ, or: −DIFFᵢ=NOMINALᵢ−ACTUALᵢ.

13. The method for the at least intermittent or periodic, preferably even ongoing, detection and monitoring of condition parameters of at least one assembly or component as in claim 10,
characterized in that
in a further method step, preferably for purposes of threshold value or limit value monitoring, difference values are compared with upper threshold or upper limit values, for example according to the arithmetic operation:

|THRESHOLDᵢ|<|DIFFᵢ|==TRUE,
wherein possibly alternatively or additionally difference values are compared with lower threshold or limit values, for example according to the arithmetic operation:

|THRESHOLDᵢ|>|DIFFᵢ|==TRUE.

14. The method for the at least intermittent or periodic, preferably even ongoing, detection and monitoring of condition parameters of at least one assembly or component as in claim 13,
characterized in that
in a further method step, preferably for the purpose of flagging or identifying known exceedances of a particular permissible limit value, a counter (k) provided for this purpose is incremented, for example according to the arithmetic operation:
IF|THRESHOLDᵢ|<|DIFFᵢ|==TRUE, THEN k=k+1, or
for example additionally or alternatively, analogously, in the case of limit value undershoots, using another counter (m) provided for this purpose, the following relation applies:
IF |DIFFᵢ|<|THRESHOLDᵢ|==TRUE, THEN m=m+1.

15. The method for the at least intermittent or periodic, preferably even ongoing, detection and monitoring of condition parameters of at least one assembly or component as in claim 14,
characterized in that
in a method step, preferably to enable early repair or service measures in the event of impending element or component damage, at least one warning data message is issued, for example in the form of a MESSAGE/DATA_ALERT message, which can be sent to a central or control computer and/or to the at least one IT and electronic system.

16. The method for the at least intermittent or periodic, preferably even ongoing, detection and monitoring of condition parameters of at least one assembly or component as in claim 15,
characterized in that
at least one warning data message is issued as soon as the number of detected exceedances of a permissible limit value (Σ|k|) reaches a critical number (n_{—crit}), for example according to the arithmetic operation:
IF (Σ|k|)>n_{—crit}, THEN MESSAGE/DATA_ALERT,
for example additionally or alternatively, analogously, in the case of limit value undershoots, using another counter (m) provided for this purpose, the following relation applies:
IF Σ|m|>p_{—crit}, THEN MESSAGE/DATA_ALERT.

17. The method for the at least intermittent or periodic, preferably even ongoing, detection and monitoring of condition parameters of at least one assembly or component as in claim 15,
characterized in that
additionally or alternatively, a separate warning data message is issued as soon as the chronological order of occurrence or the time sequence of occurrence of limit value exceedances corresponds to at least one “operating pattern known to be damaging to components or elements,” for example according to the arithmetic operation:
IF F {|THRESHOLDᵢ|}==SAMPLE_{—crit}, THEN MESSAGE/DATA—ALERT.

18. The method for the at least intermittent or periodic, preferably even ongoing, detection and monitoring of condition parameters of at least one assembly or component as in claim 10,
characterized in that
at least one, but usefully up to forty, “operating patterns known to be damaging to components or elements” are recognizable, wherein, for example, said “operating patterns known to be damaging to components or elements” are stored in the knowledge base, alternatively in the IT and electronic system.

19. The method for the at least intermittent or periodic, preferably even ongoing, detection and monitoring of condition parameters of at least one assembly or component as in claim 18, characterized by at least one selected from the group consisting of the following recognizable “operating patterns known to be damaging to components or elements”:
SAMPLE_{—crit 1}=f (wear of bearing),
SAMPLE_{—crit 2}=f (severe wear of bearing),
SAMPLE_{—crit 3}=f (chips in bearing),
SAMPLE_{—crit 4}=f (too little lubricant in bearing),
SAMPLE_{—crit 5}=f (crack formation in raceway system),
SAMPLE_{—crit 6}=f (severe crack formation in raceway system),
SAMPLE_{—crit 7}=f (pitting in raceway system),
SAMPLE_{—crit 8}=f (seizing or immobilization of bearing),
SAMPLE_{—crit 9}=f (edge chipping),
SAMPLE_{—crit 10}=f (bearing deformation),
SAMPLE_{—crit 11}=f (severe bearing deformation),
SAMPLE_{—crit 12}=f (damage to rolling elements),
SAMPLE_{—crit 13}=f (loss of rolling elements),
SAMPLE_{—crit 14}=f (aging of lubricant),
SAMPLE_{—crit 15}=f (severe aging of lubricant),
SAMPLE_{—crit 16}=f (elevated iron content in lubricant),
SAMPLE_{—crit 17}=f (decrease in bolt preload),
SAMPLE_{—crit 18}=f (severe loss of bolt preload),
SAMPLE_{—crit 19}=f (elastic deformation of raceway system),
SAMPLE_{—crit 20}=f (water in bearing),
SAMPLE_{—crit 21}=f (dimpling or scoring),
SAMPLE_{—crit 22}=f (cage wear),
SAMPLE_{—crit 23}=f (cage fracture),
SAMPLE_{—crit 24}=f (fracture of spacers),
SAMPLE_{—crit 25}=f (seal leakage),
SAMPLE_{—crit 26}=f (jamming of seal into raceway system),
SAMPLE_{—crit 27}=f (signs of impending tooth fracture),
SAMPLE_{—crit 28}=f (tooth fracture),
SAMPLE_{—crit 29}=f (wear fracture of bearing),
SAMPLE_{—crit 30}=f (bearing defect due to abrupt blade adjustment),
SAMPLE_{—crit 31}=f (bearing defect due to lightning strike),
SAMPLE_{—crit 32}=f (segmental chipping in bearing),
SAMPLE_{—crit 33}=f (segmental chipping in cage),
SAMPLE_{—crit 34}=f (partial tearing away of a blade),
SAMPLE_{—crit 35}=f (complete tearing away of a blade),
SAMPLE_{—crit 36}=f (damage to main drive shaft),
SAMPLE_{—crit 37}=f (fracture of main drive shaft),
SAMPLE_{—crit 38}=f (high lubricant pressure in bearing),
SAMPLE_{—crit 39}=f (low lubricant pressure in bearing), and
SAMPLE_{—crit 40}=f (total loss of bolt preload)
